(19) United States
(12) Patent Application Publication
(10) Pub. No.: US 2022/0398931 A1
(43) Pub. Date: Dec. 15, 2022

(54) FLIGHT SCHEDULE OPTIMIZATION METHOD BASED ON FLIGHT NORMALITY TARGET

(71) Applicant: THE 28TH RESEARCH INSTITUTE OF CHINA ELECTRONICS TECHNOLOGY GROUP CORPORATION, Nanjing (CN)

(72) Inventors: Feifei CHEN, Nanjing (CN); Hui DING, Nanjing (CN); Mingwei ZHANG, Nanjing (CN); Ming TONG, Nanjing (CN); Xiaozhu SHI, Nanjing (CN); Shan'e XU, Nanjing (CN); Fan BAO, Nanjing (CN); Jibo HUANG, Nanjing (CN); Yang ZHANG, Nanjing (CN); Xuan WANG, Nanjing (CN); Jing TIAN, Nanjing (CN); Wenyi TANG, Nanjing (CN); Zeyuan LIU, Nanjing (CN); Qingqing TAN, Nanjing (CN); Weiyu JIANG, Nanjing (CN)

(21) Appl. No.: 17/818,963

(22) Filed: Aug. 10, 2022

Related U.S. Application Data
(63) Continuation of application No. PCT/CN2022/101841, filed on Jun. 28, 2022.

(30) Foreign Application Priority Data
Nov. 1, 2021 (CN) 202111280546.3

(51) Int. Cl. G08G 5/00; G06Q 10/10

(52) U.S. Cl. CPC G08G 5/0039; G08G 5/0017; G06Q 10/1093

(57) ABSTRACT

A flight schedule optimization method based on a flight normality target is capable of carrying out pre-analysis on flight operation efficiency of a current flight schedule based on a national air traffic control service capability, and on this basis, generating a corresponding flight schedule adjustment suggestion according to a flight normality optimization target, which aims to provide a technical support means for carrying out flight schedule rationality analysis and optimization in strategic air traffic flow management.

### CROSS REFERENCES

This application is the U.S. Continuation application of International Application No. PCT/CN2022/101841 filed on 28 Jun. 2022 which designated the U.S. and claims priority to Chinese Application No. CN202111280546.3 filed on 1 Nov. 2021, the entire contents of each of which are hereby incorporated by reference.

### TECHNICAL FIELD

The present invention belongs to the field of civil aviation air traffic flow management, and more particularly, to a flight schedule optimization method based on a flight normality target.

### BACKGROUND

As an important basis for airlines, airports, air traffic control and other aviation stakeholders to carry out daily production and operation, the scheduling rationality of the flight schedule of civil aviation can have a fundamental impact on the efficiency of aviation operation. Capacity restrictions of airports are taken into consideration in making the flight schedule at current, but the consideration of airspace control service capacity is lacking. When faced with airspace overcapacity problems caused by the flight schedule, air traffic flow management authorities often issue miles in trail or other regulations in problematic airspaces to restrict flights entering the airspace, which in turn leads to flight delays. In order to minimize the flight delays and achieve the flight normality assessment target of Civil Aviation Administration to Air Traffic Management Bureau, the Air Traffic Management Bureau often guarantees the normal operation of flights through temporary negotiation at a tactical level, but such practices can hardly solve the problems at root.

### SUMMARY

Object of the present invention: the technical problem to be solved by the present invention is to provide a flight schedule optimization method based on a flight normality target for the deficiencies of the prior art. The method of the present invention comprises the following steps of:

step 1: estimating flight operation efficiency in a flight schedule;

step 2: calculating adjustment ranges and adjustment modes of flights in the flight schedule according to the normality target; and

step 3: generating a flight schedule optimization solution according to sequencing delays, priorities, the adjustment mode and the adjustment range of the flights; rescheduling the flights.

At step 1, the flight operation efficiency in the flight schedule is estimated.

The function of this step is: to analyze the flight operation efficiency of the current flight schedule without adjustment according to national airport and sector capacity restrictions by using a flight sequencing method.

The following steps are comprised:

step 1-1: defining variables;

step 1-2: filtering and sequencing flight plan; and

step 1-3: estimating the flight operation efficiency according to sequencing information.

The step 1-1 comprises: defining the following variables:

DATE: analysis date of this method, which is defined as next 7 days to the end of the current flight season at a strategic traffic management stage, and may a certain day within this range by a user as needed;

FltArray: a flight plan array, comprising all flight plans related to the analysis date DATE;

FltArrayNum: a number of flights in the flight plan array FltArray;

Fltᵢ: an i^{th} flight plan in the flight plan array FltArray;

Fltᵢ(ACID): a flight code of the flight Fltᵢ;

Fltᵢ(PRIO): a priority of the flight Fltᵢ, wherein Fltᵢ(PRIO) is a non-negative integer with an initial value of 0, and may be set by the user as needed;

Fltᵢ(STD): a sequenced time of departure of the flight Fltᵢ;

Fltᵢ(STA): a sequenced time of arrival of the flight Fltᵢ;

Fltᵢ(Delay): a sequenced takeoff delay of the flight Fltᵢ in a unit of second;

Fltᵢ(AdjMark): a sequenced adjustment mode of the flight Fltᵢ, wherein 0 represents unadjustment, 1 represents time advance, 2 represents delay, 3 represents deletion, and an initial value is 0;

FltArrayAdj: a flight plan array needing to be adjusted, representing a flight schedule set that needs to be adjusted according to the sequencing information;

FltArrayNum(Normal): a number of flights in the array FltArray that need not be adjusted according to the sequencing information, wherein an initial value is 0;

FltArrayNum(Delay): a number of flights in the array FltArray that need to be delayed or advanced according to the sequencing information, wherein an initial value is 0;

FltArrayNum(Del): a number of flights in the array FltArray that need to be deleted according to the sequencing information, wherein an initial value is 0; and

FltNormality: a flight normality estimated value in the array FltArray, wherein an initial value is 0.

The step 1-2 comprises:

filtering national flight plan of the date from the flight schedule according to the date DATE, and forming the flight plan array FltArray. Considering a national air traffic control service capacity, aiming at ensuring that national airports and sectors do not exceed the capacity, a combination method of time adjustment and flight deletion is adopted to adjust the flights in FltArray, and generate sequencing information of each flight Fltᵢ, wherein the flight sequencing information comprises:
1) the sequenced time of departure Fltᵢ(STD);
2) the sequenced time of arrival Fltᵢ(STA);
3) the sequencing delay Fltᵢ(Delay); and
4) the adjustment mode Fltᵢ(AdjMark) of the flight.

Note 1: the related flight sequencing method has been detailed in the earlier patent “Flight Operation Efficiency Pre-evaluation Method Based on Flight Schedule”, and will not be elaborated herein.

At step 1-3, the flight operation efficiency is estimated according to the sequencing information.

All flights in the flight plan array FltArray satisfying that Fltᵢ(AdjMark)>0 are added into the array FltArrayAdj.

The following indexes are calculated according to the sequenced adjustment mode Fltᵢ(AdjMark) of the flight in the flight plan array FltArray
1) flight delay number index FltArrayNum(Delay); and
2) flight deletion number index FltArrayNum(Del).

Calculation formulas of the flight normality index in this method are as follows:

$$FltA r r a y N u m ( N o r m a l ) = FltA r r a yNum - FltArrayNum ( D e l a y ) - F l t A r r a y N u m ( Del ) \qquad ( 1 )$$

$$FltNormality = \frac{F l t A r r a y N u m ( N o r m a l )}{F l t A r r a y N u m} . \qquad ( 2 )$$

Note 2: the indexes above are used to reflect the flight operation situation of the current flight schedule without adjustment.

Note 3: the Air Traffic Management Bureau of Civil Aviation Administration has published a variety of statistical methods of flight normality, which are constantly changing. In this patent, at a level of strategic air traffic flow management, the greatest potential of the normal operation of national flights under the current airspace service capacity is tapped, and an optimization solution is provided. Therefore, a flight normality statistical method is defined as formula (2), and a user may change the statistical method as needed.

At step 2, the adjustment ranges and the adjustment modes of the flights in the flight schedule are calculated according to the normality target.

The function of this step is: to calculate a flight volume that needs time adjustment and deletion in advance according to a set flight normality target.

The following steps are comprised:

step 2-1: defining variables;

step 2-2: making relevant settings;

step 2-3: setting the flight normality optimization target; and

step 2-4: calculating the adjustment ranges and the adjustment modes of the flights according to the normality target.

Note 4: The earlier patent “Airspace Network Optimization Method Based on Flight Normality Target” provides an airspace network optimization method, which can improve flight normality by expanding an airspace service capacity without modifying the current flight schedule. On the contrary, the target of the present invention focuses on how to achieve the target of improving the flight normality by modifying the flight schedule under the current situation of airspace network resources, so the realization principles and calculation methods are different.

The step 2-1 comprises: defining the following variables:

TargetNormality: the flight normality optimization target set in the calculating process of the method;

TmpNormality: a flight normality temporary variable in the calculating process of the method;

TargetNum(Del): a number of flights that need to be deleted by filtering according to the normality target, wherein an initial value is 0;

TargetNum(Adj): a number of flights that need time adjustment by filtering according to the normality target, wherein an initial value is 0; and

TargetNum(Total): a number of flights that need time adjustment or deletion by filtering according to the normality target, wherein an initial value is 0.

The step 2-2 comprises:

recording the flight plan array FltArray as an array A, wherein the flight normality of the array A is estimated as FltNormality based on the step 1-3.

When the flights in the array FltArray are completely corrected according to the sequencing result of the step 1-2, an array B is generated. The array B is capable of satisfying the national air traffic control service capacity, and no flight needs time adjustment or deletion according to the sequencing result of the step 1-2, so the flight normality estimated value of the array B is 100%.

When a user sets the flight normality optimization target as TargetNormality, an appropriate number of flights are selected from the flight adjustment array FltArrayAdj in this method, and the array FltArray is amended according to the flight sequencing information to generate an array C, wherein the adjusted flight volume TargetNum(Total) filtered from FltArrayAdj needs to satisfy formula (3) and formula (4):

$$T arg etNormality = \frac{F l t A r r a y N u m ( N o r m a l ) + T arg etNum ( Adj )}{F l t A r r a y N u m - T arg etNum ( D e l )} , and \\ T arg etNum ( A d j ) ∈ [ 0 , F l t A r r a y N u m ( D e l a y ) ] , \\ T arg etNum ( D e l ) ∈ [ 0 , F l t A r r a y N u m ( D e l ) ] \qquad ( 3 )$$

$$T arg etNum ( T o t a l ) = T arg etNum ( A d j ) + T arg etNum ( D el ) . \qquad ( 4 )$$

In order to prove that the array C can achieve the flight normality optimization target TargetNormality in actual implementation, the following explanation is needed.

According to the sequencing result of the step 1-2, in order to ensure that the national air traffic control service capacity is not exceeded, (FltArrayNum(Delay)−TargetNum(Adj)) flights that need time adjustment and (FltArrayNum(Del)−TargetNum(Del)) flights that need deletion still exist in the array C; if the array C is actually executed by adjusting these flights with reference to the sequencing information of the flight in the step 1-2, it is guaranteed that the national air traffic control service capacity is not exceeded; thus, it is possible to prove the existence of at least one operation method that enables the array C to achieve the flight normality optimization target with reference to formula (5).

A formula for verifying the flight normality of the array C is as follows:

$$\begin{matrix}TmpNormality = \frac{\begin{matrix}( Flt A r r a y N u m - T arg etNum ( D e l ) ) - \\ ( FltArrayNum ( D e l a y ) - T arg etNum ( A d j ) ) - \\ ( FltArrayNum ( D e l ) - T arg etNum ( D e l ) )\end{matrix}}{FltA r r a y N u m - T arg etNum ( D e l )} \\ = \frac{\begin{matrix}FltA r r a y N u m - F l t A r r a y N u m ( D e l a y ) - \\ FltArrayNum ( D e l ) + T arg etNum ( A d j )\end{matrix}}{FltA r r a y N um - T arg etNum ( D e l )} \\ = \frac{FltA r r a y N u m ( N o r m a l ) + T arg etNum ( A d j )}{FltA r r a y N um - T arg etNum ( D e l )} \\ = T arg etNormality\end{matrix} \qquad ( 5 )$$

At step 2-3, the flight normality optimization target is set.

The object of the present invention is to optimize the flight schedule and improve the flight normality in actual operation. Therefore, it is necessary to limit the flight normality optimization target TargetNormality set by the user, which needs to satisfy that TargetNormality∈[FltNormality,1].

The step 2-4 comprises:

in order to achieve the flight normality optimization target TargetNormality, it is necessary to filter TargetDelNum flights from the flight plan array for deletion and TargetAdjNum flights for time adjustment; as described in the step 1-3, these flights are comprised in the array FltArrayAdj.

Considering that economic losses caused by flight deletion in actual operation are higher than that caused by flight delay, this method gives priority to the flight that may be deleted when making the flight schedule optimization solution, so as to reduce flight deletion behaviors in actual operation. The user may adjust preferences thereof for filtering flights as needed.

Step 2-4-1: calculating a deleted flight volume:

firstly, trying to achieve the normality optimization target by only deleting flight:

letting

$$T arg etNormality = \frac{FltArrayNum ( Normal )}{F l t A r r a y N u m - T arg etNum ( Del )} ,$$

then:

$$T arg etNum ( D e l ) = FltA r r a yNum - \frac{FltArrayNum ( Normal )}{T arg etNormality} \qquad ( 6 )$$

when satisfying that TargetNum(Del)>FltArrayNum(Del), indicating that it is failed to achieve the flight normality target by deleting the flights only, letting TargetNum(Del)=FltArrayNum(Del), and continuously executing step 2-4-2; otherwise, letting TargetNum(Adj)=0, and skipping to step 2-4-3;

step 2-4-2: calculating a time-adjusted flight volume:

letting

$$T arg etNormality = \frac{FltArrayNum ( Normal ) + T arg etNum ( A d j )}{F l t A r r a y N u m - T arg etNum ( Del )} ,$$

then:

TargetNum(Adj)=TargetNormality*(FltArrayNum−TargetNum(Del))−FltArrayNum(Normal) (7);

and step 2-4-3: calculating a total adjusted flight volume:

TargetNum(Total)=TargetNum(Adj)+TargetNum(Del) (8).

At step 3, the flight schedule optimization solution is generated.

The function of this step is: to generate the flight schedule optimization solution by filtering the corresponding flights according to the sequencing delays, priorities, the adjustment mode and the adjustment range of the flights.

The following steps are comprised:

step 3-1: defining variables;

step 3-2: optimizing a sequence of the flight adjustment array; and

step 3-3: generating a flight schedule adjustment solution;

wherein in the step 3-1, the following variables are defined:

FltOptyList: flight adjustment solution, comprising the flights that need deletion or time adjustment filtered from the flight array FltArray in order to achieve the normality optimization target TargetNormality;

FltOptyᵢ: an i^{th} flight that needs to be optimized in FltOptyList;

FltOptyᵢ(CODE): a flight code of the flight FltOptyᵢ;

FltOptyᵢ(AdjMark): a flight adjustment mode type of FltOptyᵢ, wherein 0 represents time adjustment, and 1 represents suggested deletion;

FltOptyᵢ(STD): suggested time of departure of FltOptyᵢ;

FltOptyᵢ(STA): suggested time of arrival of FltOptyᵢ; and

MAX_DELAY: a maximum flight delay default in this method, which is set as 9999*60 seconds in this method, and may be adjusted by the user as needed.

The step 3-2 comprises:

for the flight adjustment array FltArrayAdj generated in the step 1-3, in order to distinguish the severity of flight operation problems, according to the delay situation Fltᵢ(Delay), the priority Fltᵢ(PRIO) and the adjustment mode Fltᵢ(AdjMark) of each flight Fltᵢ in the array FltArrayAdj, the sequence of the flights in the array FltArrayAdj is optimized in a descending sequence of severity.

Step 3-2-1: updating delay information of flights suggested to be deleted:

for each flight Fltᵢ in the array FltArrayAdj, when the adjustment mode Fltᵢ(AdjMark) of the flight is 3, indicating that the flight is suggested to be deleted, letting the flight be that Fltᵢ(Delay)=MAX_DELAY; and

on the basis of the step 3-2-2, sequencing the flights in a descending sequence of priorities according to the priority Fltᵢ(PRIO) of each flight Fltᵢ in the array FltArrayAdj, and updating the flight sequence in the array FltArrayAdj.

Step 3-2-2: sequencing according to delay situations of the flights:

sequencing the flights in a descending sequence of delays according to the delay situation Fltᵢ(Delay) of each flight Fltᵢ in the array FltArrayAdj, and updating a flight sequence in the array FltArrayAdj.

Step 3-2-3: sequencing according to the priorities of the flights:

In order to highlight the operation problems of high-priority flights, on the basis of the step 3-2-2, sequencing the flights in a descending sequence of priorities according to the priority Fltᵢ(PRIO) of each flight Fltᵢ in the array FltArrayAdj, and updating the flight sequence in the array FltArrayAdj.

The step 3-3 comprises:

according to the deleted flight volume TargetNum(Del) and the time-adjusted flight volume TargetNum(Adj) obtained in the step 2-4, filtering a corresponding number of time adjusted flights and deleted flights from the array FltArrayAdj as the flight adjustment solution.

Step 3-3-1: filtering deleted flights:

filtering TargetNum(Del) flights Fltᵢ with an adjustment mode Fltᵢ(AdjMark) of 3 from a head of the array FltArrayAdj, defining the flights as flights FltOptyₖ to be optimized, and letting FltOptyₖ(CODE)=Fltᵢ(ACID), and FltOptyₖ(AdjMark)=1; and adding FltOptyₖ into the flight adjustment solution FltOptyList.

Step 3-3-2: filtering time adjusted flights:

filtering TargetNum(Adj) flights Fltᵢ with an adjustment mode Fltᵢ(AdjMark) of 1 or 2 from the head of the array FltArrayAdj, defining the flights Fltᵢ as flights FltOptyₖ to be optimized, and letting FltOptyₖ(CODE)=Fltᵢ(ACID), FltOptyₖ (AdjMark)=0, FltOptyₖ(STD)=Fltᵢ(STD) and FltOptyₖ(STA)=Fltᵢ(STA); and adding FltOptyₖ into the flight adjustment solution FltOptyList.

in the present invention, the flight schedule adjustment of the airplane flight is executed according to the flight schedule optimization solution obtained in the step 3.

The flight schedule optimization method based on the flight normality target according to the present invention is loaded and operated in a processing server of an air traffic flow management system (ATFM system) or a corresponding computer of an air traffic control system (ATC system).

The present invention has the beneficial effects that: according to the method of the present invention, on the basis of carrying out pre-analysis on the flight operation efficiency of the current flight schedule, the flight schedule optimization method based on the flight normality target is provided, which can generate the corresponding national flight schedule adjustment suggestion according to the set flight normality optimization target and provide technical support for carrying out flight schedule optimization at a strategic level.

### BRIEF DESCRIPTION OF THE DRAWINGS

The advantages of the above and/or other aspects of the present invention will become more apparent by further explaining the present invention with reference to the following drawings and detailed description.

FIG. 1 is a processing flow chart of the present invention.

FIG. 2 is a schematic diagram of a generation principle of a flight schedule optimization solution based on a flight normality optimization target of the present invention.

FIG. 3 is a schematic diagram of a flight schedule analysis result of the present invention.

### DETAILED DESCRIPTION

A method of the present invention comprises the following steps of:

step 1: estimating flight operation efficiency in a flight schedule, wherein the flight operation efficiency of the current flight schedule is estimated according to national airport and sector capacity restrictions by using a flight sequencing method;

step 2: calculating adjustment ranges and adjustment modes of flights in the flight schedule according to the normality target; and

step 3: generating a flight schedule optimization solution, wherein the flight schedule optimization solution is generated according to sequencing delays, priorities, the adjustment modes and the adjustment range of the flights.

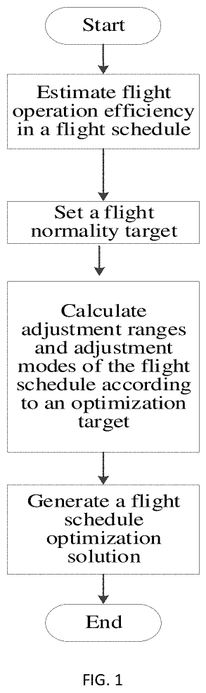

The overall processing flow is shown in FIG. 1.

At step 1, the flight operation efficiency in the flight schedule is estimated.

The function of this step is: to analyze the flight operation efficiency of the current flight schedule without adjustment according to national airport and sector capacity restrictions by using a flight sequencing method.

The following steps are comprised:

step 1-1: defining variables;

step 1-2: filtering and sequencing flight plan; and

step 1-3: estimating the flight operation efficiency according to sequencing information.

At step 1-1, the variables are defined:

DATE: analysis date of this method, which is defined as next 7 days to the end of the current flight season at a strategic traffic management stage, and may a certain day within this range by a user as needed;

FltArray: a flight plan array, comprising all flight plans related to the analysis date DATE;

FltArrayNum: a number of flights in the flight plan array FltArray;

Fltᵢ: an i^{th} flight plan in the flight plan array FltArray;

Fltᵢ(ACID): a flight code of the flight Fltᵢ;

Fltᵢ(PRIO): a priority of the flight Fltᵢ, wherein Fltᵢ(PRIO) is a non-negative integer with an initial value of 0, and may be set by the user as needed;

Fltᵢ(STD): a sequenced time of departure of the flight Fltᵢ;

Fltᵢ(STA): a sequenced time of arrival of the flight Fltᵢ;

Fltᵢ(Delay): a sequenced takeoff delay of the flight Fltᵢ in a unit of second;

Fltᵢ(AdjMark): a sequenced adjustment mode of the flight Fltᵢ, wherein 0 represents unadjustment, 1 represents time advance, 2 represents delay, 3 represents deletion, and an initial value is 0;

FltArrayAdj: a flight plan array needing to be adjusted, representing a flight schedule set that needs to be adjusted according to the sequencing information;

FltArrayNum(Normal): a number of flights in the array FltArray that need not be adjusted according to the sequencing information, wherein an initial value is 0;

FltArrayNum(Delay): a number of flights in the array FltArray that need to be delayed or advanced according to the sequencing information, wherein an initial value is 0;

FltArrayNum(Del): a number of flights in the array FltArray that need to be deleted according to the sequencing information, wherein an initial value is 0; and

FltNormality: a flight normality estimated value in the array FltArray, wherein an initial value is 0.

At step 1-2, the flight plans are filtered and sequenced:

filtering national flight plan of the date from the flight schedule according to the date DATE, and forming the flight plan array FltArray. Considering a national air traffic control service capacity, aiming at ensuring that national airports and sectors do not exceed the capacity, a combination method of time adjustment and flight deletion is adopted to adjust the flights in FltArray, and generate sequencing information of each flight Fltᵢ, wherein the flight sequencing information comprises:
1) the sequenced time of departure Fltᵢ(STD);
2) the sequenced time of arrival Fltᵢ(STA);
3) the sequencing delay Fltᵢ(Delay); and
4) the adjustment mode Fltᵢ(AdjMark) of the flight.

Note 1: the related flight sequencing method has been detailed in the earlier patent “Flight Operation Efficiency Pre-evaluation Method Based on Flight Schedule”, and will not be elaborated herein.

At step 1-3, the flight operation efficiency is estimated according to the sequencing information.

All flights in the flight plan array FltArray satisfying that Fltᵢ(AdjMark)>0 are added into the array FltArrayAdj.

The following indexes are calculated according to the sequenced adjustment mode Fltᵢ(AdjMark) of the flight in the flight plan array FltArray
1) flight delay number index FltArrayNum(Delay); and
2) flight deletion number index FltArrayNum(Del).

Calculation formulas of the flight normality index in this method are as follows:

$$FltArrayNum ( Normal ) = FltArrayNum ( Delay ) - FltArrayNum ( Del ) \qquad ( 1 )$$

$$FltNormality = \frac{FltArrayNum ( Normal )}{F l t A r r a y N u m} . \qquad ( 2 )$$

Note 2: the indexes above are used to reflect the flight operation situation of the current flight schedule without adjustment.

Note 3: the Air Traffic Management Bureau of Civil Aviation Administration has published a variety of statistical methods of flight normality, which are constantly changing. In this patent, at a level of strategic air traffic flow management, the greatest potential of the normal operation of national flights under the current airspace service capacity is tapped, and an optimization solution is provided. Therefore, a flight normality statistical method is defined as formula (2), and a user may change the statistical method as needed.

At step 2, the adjustment ranges and the adjustment modes of the flights in the flight schedule are calculated according to the normality target.

The function of this step is: to calculate a flight volume that needs time adjustment and deletion in advance according to a set flight normality target.

The following steps are comprised:

step 2-1: defining variables;

step 2-2: introducing principles;

step 2-3: setting the flight normality optimization target; and

step 2-4: calculating the adjustment ranges and the adjustment modes of the flights according to the normality target.

Note 4: The earlier patent Airspace Network Optimization Method Based on Flight Normality Target provides an airspace network optimization method, which can improve flight normality by expanding an airspace service capacity without modifying the current flight schedule. On the contrary, the target of the patent focuses on how to achieve the target of improving the flight normality by modifying the flight schedule under the current situation of airspace network resources, so the realization principles and calculation methods are different.

At step 2-1, the variables are defined:

The step 2-1 comprises: defining the following variables:

TargetNormality: the flight normality optimization target set in the calculating process of the method;

TmpNormality: a flight normality temporary variable in the calculating process of the method;

TargetNum(Del): a number of flights that need to be deleted by filtering according to the normality target, wherein an initial value is 0;

TargetNum(Adj): a number of flights that need time adjustment by filtering according to the normality target, wherein an initial value is 0; and

TargetNum(Total): a number of flights that need time adjustment or deletion by filtering according to the normality target, wherein an initial value is 0.

At step 2-2, the principles are introduced:

When the flights in the array FltArray are completely corrected according to the sequencing result of the step 1-2, an array B is generated. The array B is capable of satisfying the national air traffic control service capacity, and no flight needs time adjustment or deletion according to the sequencing result of the step 1-2, so the flight normality estimated value of the array B is 100%.

When a user sets the flight normality optimization target as TargetNormality, an appropriate number of flights are selected from the flight adjustment array FltArrayAdj in this method, and the array FltArray is amended according to the flight sequencing information to generate an array C, wherein the adjusted flight volume TargetNum(Total) filtered from FltArrayAdj needs to satisfy formula (3) and formula (4):

$$T arg etNormality = \frac{F l t A r r a y N u m ( N o r m a l ) + T arg etNum ( Adj )}{F l t A r r a y N u m - T arg etNum ( D e l )} , and \\ T arg etNum ( A d j ) ∈ [ 0 , F l t A r r a y N u m ( Delay ) ] , \\ T arg etNum ( D e l ) ∈ [ 0 , F l t A r r a y N u m ( D e l ) ] \qquad ( 3 )$$

$$T arg etNum ( T o t a l ) = T arg etNum ( A d j ) + T arg etNum ( D el ) . \qquad ( 4 )$$

In order to prove that the array C can achieve the flight normality optimization target TargetNormality in actual implementation, the following explanation is needed.

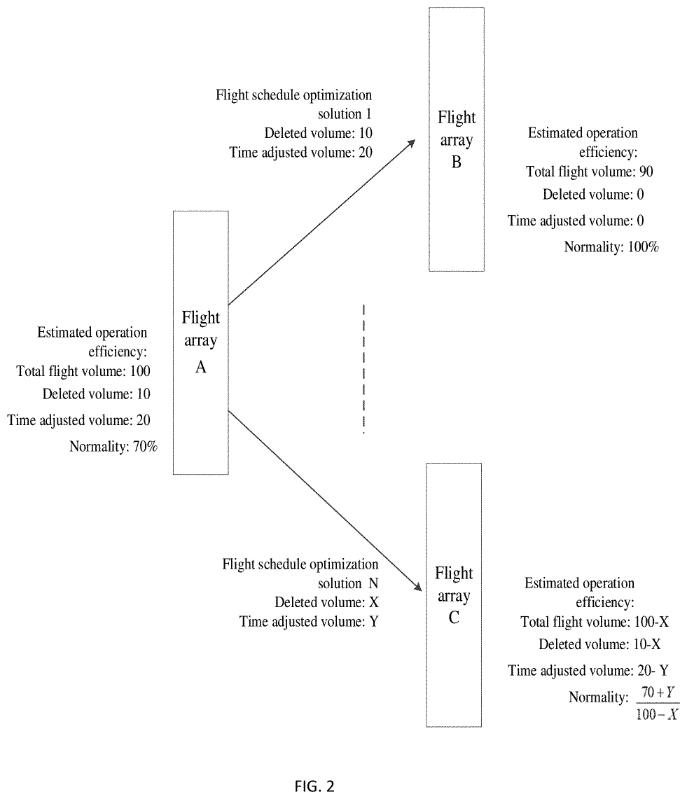

According to the sequencing result of the step 1-2, in order to ensure that the national air traffic control service capacity is not exceeded, (FltArrayNum(Delay)−TargetNum(Adj)) flights that need time adjustment and (FltArrayNum(Del)−TargetNum(Del)) flights that need deletion still exist in the array C; if the array C is actually executed by adjusting these flights with reference to the sequencing information of the flight in the step 1-2, it is guaranteed that the national air traffic control service capacity is not exceeded; thus, it is possible to prove the existence of at least one operation method that enables the array C to achieve the flight normality optimization target with reference to formula (5). The principles are shown in FIG. 2.

A formula for verifying the flight normality of the array C is as follows:

$$\begin{matrix}TmpNormality = \frac{\begin{matrix}( FltArrayNum - T arg etNum ( Del ) ) - \\ ( FltArrayNum ( Delay ) - T arg etNum ( Adj ) ) - \\ ( FltArrayNum ( Del ) - T arg etNum ( Del ) )\end{matrix}}{FltArrayNum - T arg etNum ( Del )} \\ = \frac{\begin{matrix}FltArrayNum - FltArrayNum ( Delay ) - \\ FltArrayNum ( Del ) + T arg etNum ( Adj )\end{matrix}}{FltArrayNum - T arg etNum ( Del )} \\ = \frac{FltArrayNum ( Normal ) + T arg etNum ( Adj )}{FltArrayNum - T arg etNum ( Del )} \\ = T arg etNormality\end{matrix} \qquad ( 5 )$$

At step 2-3, the flight normality optimization target is set.

The object of the present invention is to optimize the flight schedule and improve the flight normality in actual operation. Therefore, it is necessary to limit the flight normality optimization target TargetNormality set by the user, which needs to satisfy that TargetNormality∈[FltNormality,1].

At step 2-4, the adjustment ranges and the adjustment modes of the flights are calculated according to the normality target:

in order to achieve the flight normality optimization target TargetNormality, it is necessary to filter TargetDelNum flights from the flight plan array for deletion and TargetAdjNum flights for time adjustment; as described in the step 1-3, these flights are comprised in the array FltArrayAdj.

Considering that economic losses caused by flight deletion in actual operation are higher than that caused by flight delay, this method gives priority to the flight that may be deleted when making the schedule optimization solution, so as to reduce flight deletion behaviors in actual operation. The user may adjust preferences thereof for filtering flights as needed.

At step 2-4-1, a deleted flight volume is calculated:

firstly, trying to achieve the normality optimization target by only deleting flight:

letting

$$T arg etNormality = \frac{F l t A r r a y N u m ( N o r m a l )}{F l t A r r a y N u m - T arg etNum ( D e l )} ,$$

then:

$$T arg etNum ( D e l ) = FltA r r a yNum - \frac{F l t A r r a y N u m ( N o r m a l )}{T arg etNormality} \qquad ( 6 )$$

when satisfying that TargetNum(Del)>FltArrayNum(Del), indicating that it is failed to achieve the flight normality target by deleting the flights only, letting TargetNum(Del)=FltArrayNum(Del), and continuously executing step 2-4-2; otherwise, letting TargetNum(Adj)=0, and skipping to step 2-4-3.

At step 2-4-2, a time-adjusted flight volume is calculated:

letting

$$T arg etNormality = \frac{F l t A r r a y N u m ( N o r m a l ) + T arg etNum ( A d j )}{F l t A r r a y N u m - T arg etNum ( D e l )} ,$$

then:

TargetNum(Adj)=TargetNormality*(FltArrayNum−TargetNum(Del))−FltArrayNum(Normal) (7).

At step 2-4-3, a total adjusted flight volume is calculated:

TargetNum(Total)=TargetNum(Adj)+TargetNum(Del) (8).

At step 3: the flight schedule optimization solution is generated.

The function of this step is: to generate the flight schedule optimization solution by filtering the corresponding flights according to the sequencing delays, priorities, the adjustment modes and the adjustment range of the flights.

The following steps are comprised:

step 3-1: defining variables;

step 3-2: optimizing a sequence of the flight adjustment array;

step 3-3: generating a flight schedule adjustment solution; and

step 3-4: application examples.

At step 3-1, the variables are defined:

FltOptyList flight adjustment solution, comprising the flights that need deletion or time adjustment filtered from the flight array FltArray in order to achieve the normality optimization target TargetNormality;

FltOptyᵢ: an flight that needs to be optimized in FltOptyList;

FltOptyᵢ(CODE): a flight code of the flight FltOptyᵢ;

FltOptyᵢ(AdjMark): a flight adjustment mode type of FltOptyᵢ, wherein 0 represents time adjustment, and 1 represents suggested deletion;

FltOptyᵢ(STD): suggested time of departure of FltOptyᵢ;

FltOptyᵢ(STA): suggested time of arrival of FltOptyᵢ; and

MAX_DELAY: a maximum flight delay default in this method, which is set as 9999*60 seconds in this method, and may be adjusted by the user as needed.

At step 3-2, a sequence of the flight adjustment arrays is optimized:

for the flight adjustment array FltArrayAdj generated in the step 1-3, in order to distinguish the severity of flight operation problems, according to the delay situation Fltᵢ(Delay), the priority Fltᵢ(PRIO) and the adjustment mode Fltᵢ(AdjMark) of each flight Fltᵢ in the array FltArrayAdj, the sequence of the flights in the array FltArrayAdj is optimized in a descending sequence of severity.

At step 3-2-1, delay information of flights suggested to be deleted is updated:

for each flight Fltᵢ in the array FltArrayAdj, when the adjustment mode Flt (AdjMark) of the flight is 3, indicating that the flight is suggested to be deleted, letting the flight be that Fltᵢ(Delay)=MAX_DELAY.

At step 3-2-2, sequencing is performed according to delay situations of the flights:

sequencing the flights in a descending sequence of delays according to the delay situation Fltᵢ(Delay) of each flight Fltᵢ in the array FltArrayAdj, and updating a flight sequence in the array FltArrayAdj.

At step 3-2-3, sequencing is performed according to the priorities of the flights:

In order to highlight the operation problems of high-priority flights, on the basis of the step 3-2-2, sequencing the flights in a descending sequence of priorities according to the priority Fltᵢ(PRIO) of each flight Fltᵢ in the array FltArrayAdj, and updating the flight sequence in the array FltArrayAdj.

At step 3-3, a flight schedule optimization solution is generated:

according to the deleted flight volume TargetNum(Del) and the time-adjusted flight volume TargetNum(Adj) obtained in the step 2-4, filtering a corresponding number of time adjusted flights and deleted flights from the array FltArrayAdj as the flight adjustment solution.

At step 3-3-1, deleted flights are filtered:

filtering TargetNum(Del) flights Fltᵢ with an adjustment mode Fltᵢ(AdjMark) of 3 from a head of the array FltArrayAdj, defining the flights as flights FltOptyₖ to be optimized, and letting FltOptyₖ(CODE)=Fltᵢ(ACID), and FltOptyₖ(AdjMark)=1; and adding FltOptyₖ into the flight adjustment solution FltOptyList.

At step 3-3-2, time adjusted flights are filtered:

filtering TargetNum(Adj) flights Fltᵢ with an adjustment mode Fltᵢ(AdjMark) of 1 or 2 from the head of the array FltArrayAdj, defining the flights as flights FltOptyₖ to be optimized, and letting FltOptyₖ(CODE)=Fltᵢ(ACID), FltOptyₖ(AdjMark)=0, FltOptyₖ(STD)=Fltᵢ(STD) and FltOptyₖ(STA)=Fltᵢ(STA); and adding FltOptyₖ into the flight adjustment solution FltOptyList.

Step 3-4: application examples.

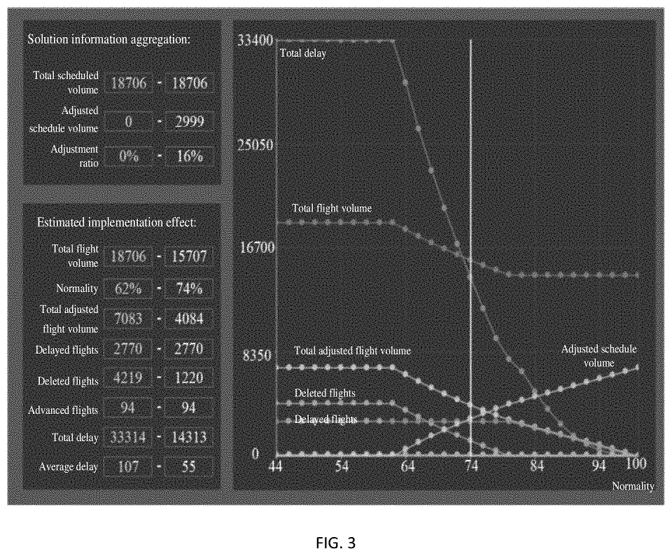

A flight schedule analysis and optimization system module can be constructed by adopting the present invention. In view of format requirements, the flight schedule analysis result is only shown in a schematic diagram, which is as shown in FIG. 3. The diagram is divided into three areas according to functions: a solution information aggregation area in an upper left corner, a solution implementation effect evaluation area in a lower left corner, and a solution selection area in a right side. Each area is briefly introduced to reflect the specific application of the method provided by the present invention with reference to certain flight schedule analysis results below.

1) Solution Selection Area

This area supports viewing the efficiency evaluation results of flight schedule optimization solutions corresponding to different flight normality targets. By adopting the method provided by the present invention, in a flight normality interval of [the flight normality evaluation value FltNormality of the current flight schedule, 100%], the flight schedule optimization solutions under different flight normality targets and the related flight efficiency evaluation results are automatically calculated by taking 2% as a step length. A horizontal axis of this area reflects a selection range of the flight normality target, and a vertical axis of this area reflects an efficiency index evaluation value after the implementation of the flight schedule optimization solution corresponding to the flight normality optimization target. This area can reflect efficiency change trends of the flight schedule optimization solutions corresponding to different flight normality optimization targets. For example, when an expected flight normality target is higher, although the adjusted flight volume comprised in the flight schedule optimization solution is larger, resulting in more complicated coordination work, the flight delay and deletion situations of the optimized flight schedule are improved. When the flight normality optimization target is selected on the horizontal axis, the solution information aggregation area displays the corresponding flight schedule optimization solution information, and the solution implementation effect evaluation area displays the flight efficiency estimation results of the corresponding flight schedule optimization solutions.

2) Solution Implementation Effect Estimation Area

This area is used to compare and display the flight operation efficiency before and after the implementation of the flight schedule optimization solution. See the step 1 for the specific estimation method. Index values on a left side of this area reflect the flight operation efficiency estimation of the current flight schedule without adjustment. As shown in FIG. 3, data analysis results of this embodiment are as follows: a total scheduled flight volume extracted from the flight schedule on the current analysis date is 18,706 flights; under the currently set national airport and sector capacity, it is estimated that a flight volume of FltArrayNum(Delay)=2770+94=2864 is delayed, a flight volume of FltArrayNum(Del)=4219 is deleted; and a flight normality estimated value according to the step 1 is that FltNormality=62%; indexes on a right side of this area reflect efficiency comparison results after the flight schedule optimization solution takes effect. The flight schedule optimization solution improves the flight normality TargetNormality to 74%, and the total number of deleted flights drops to 1,220, while other indexes also comprise a total delay, an average delay, or the like. The implementation effects of the flight schedule optimization solution are judged by index comparison.

3) Solution Information Aggregation Area

This area supports viewing the information of the flight schedule optimization solution.

When the flight normality optimization target is selected in the solution selection area, this area displays the corresponding information of the flight schedule optimization solution. For example, as shown in FIG. 3, the flight normality optimization target TargetNormality selected by the user is 74%; it may be known from the step 2-4 that the flight normality optimization target may can be achieved by deleting the flight volume in the flight schedule only, and TargetNum(Del)=2999, and TargetNum(Adj)=0; for example, the flight volume needing to be adjusted in a flight schedule displayed on a right side of this area in FIG. 3 is 2,999, and an adjustment ratio is 16%. The specific affected flights in the flight schedule may be generated according to the step 3 on this basis.

The flight schedule adjustment of the airplane flight is executed according to the flight schedule optimization solution obtained in the step 3.

The flight schedule optimization method based on the flight normality target according to this embodiment is loaded and operated in a processing server of an air traffic flow management system (ATFM system) or a corresponding computer of an air traffic control system (ATC system).

In a specific implementation, the present application provides a computer storage medium and a corresponding data processing unit, wherein the computer storage medium is capable of storing a computer program, and the computer program, when executed by the data processing unit, can run the inventive contents of the flight schedule optimization method based on the flight normality target provided by the present invention and some or all steps in various embodiments. The storage medium may be a magnetic disk, an optical disk, a Read Only Storage (ROM) or a Random Access Storage (RAM), and the like.

Those skilled in the art can clearly understand that the technical solutions in the embodiments of the present invention can be realized by means of a computer program and a corresponding general hardware platform thereof. Based on such understanding, the essence of the technical solutions in the embodiments of the present invention or the part contributing to the prior art, may be embodied in the form of a computer program, i.e., a software product. The computer program, i.e., the software product is stored in a storage medium comprising a number of instructions such that a device (which may be a personal computer, a server, a singlechip, a MUU or a network device, and the like) comprising the data processing unit executes the methods described in various embodiments or some parts of the embodiments of the present invention.

The present invention provides the flight schedule optimization method based on the flight normality target. There are many methods and ways to realize the technical solutions. The above is only the preferred embodiments of the present invention. It should be pointed out that those of ordinary skills in the art can make some improvements and embellishments without departing from the principle of the present invention, and these improvements and embellishments should also be regarded as falling with the scope of protection of the present invention. All the unspecified components in the embodiments can be realized by the prior art.

What is claimed is:

1. A flight schedule optimization method based on a flight normality target, comprising the following steps of:
step 1: estimating flight operation efficiency in a flight schedule;
step 2: calculating adjustment ranges and adjustment modes of flights in the flight schedule according to the normality target; and
step 3: generating a flight schedule optimization solution according to sequencing delays, priorities, the adjustment modes and the adjustment range of the flights; rescheduling the flights.

2. The flight schedule optimization method based on the flight normality target according to claim 1, wherein the step 1 comprises:
step 1-1: defining variables;
step 1-2: filtering and sequencing flight plan; and
step 1-3: estimating the flight operation efficiency according to sequencing information.

3. The flight schedule optimization method based on the flight normality target according to claim 2, wherein the step 1-1 comprises: defining the following variables:
DATE: analysis date;
FltArray: a flight plan array, comprising all flight plans related to the analysis date DATE;
FltArrayNum: a number of flights in the flight plan array FltArray;
Fltᵢ: an i^{th} flight plan in the flight plan array FltArray;
Fltᵢ(ACID): a flight code of the flight Fltᵢ;
Fltᵢ(PRIO): a priority of the flight Fltᵢ, wherein Fltᵢ(PRIO) is a non-negative integer with an initial value of 0;
Fltᵢ(STD): a sequenced time of departure of the flight Fltᵢ;
Fltᵢ(STA): a sequenced time of arrival of the flight Fltᵢ;
Fltᵢ(Delay): a sequenced takeoff delay of the flight Fltᵢ in a unit of second;
Fltᵢ(AdjMark): a sequenced adjustment mode of the flight Fltᵢ, wherein 0 represents unadjustment, 1 represents time advance, 2 represents delay, 3 represents deletion, and an initial value is 0;
FltArrayAdj: a flight plan array needing to be adjusted;
FltArrayNum(Normal): a number of flights in the array FltArray that need not be adjusted according to the sequencing information, wherein an initial value is 0;
FltArrayNum(Delay): a number of flights in the array FltArray that need to be delayed or advanced according to the sequencing information, wherein an initial value is 0;
FltArrayNum(Del): a number of flights in the array FltArray that need to be deleted according to the sequencing information, wherein an initial value is 0; and
FltNormality: a flight normality estimated value in the array FltArray, wherein an initial value is 0.

4. The flight schedule optimization method based on the flight normality target according to claim 3, wherein the step 1-2 comprises: filtering national flight plan of the date from the flight schedule according to the date DATE, forming the flight plan array FltArray, and generating sequencing information of each flight Fltᵢ, wherein the flight sequencing information comprises the sequenced time of departure Fltᵢ(STD), the sequenced time of arrival Fltᵢ(STA), the sequencing delay Fltᵢ(Delay) and the adjustment modes Fltᵢ(AdjMark) of the flight.

5. The flight schedule optimization method based on the flight normality target according to claim 4, wherein the step 1-3 comprises:
all flights in the flight plan array FltArray satisfying that Fltᵢ(AdjMark)>0 are added into the array FltArrayAdj;
calculating a flight delay number index FltArrayNum(Delay) and a flight deletion number index FltArrayNum(Del) according to the sequenced adjustment mode Fltᵢ(AdjMark) of the flight in the flight plan array FltArray
$$FltA r r a y N u m ( N o r m a l ) = FltA r r a yNum - FltArrayNum ( D e l a y ) - F l t A r r a y N u m ( Del ) \qquad ( 1 )$$
$$FltNormality = \frac{F l t A r r a y N u m ( N o r m a l )}{F l t A r r a y N u m} . \qquad ( 2 )$$

6. The flight schedule optimization method based on the flight normality target according to claim 5, wherein the step 2 comprises the following steps of:
step 2-1: defining variables;
step 2-2: making relevant settings;
step 2-3: setting the flight normality optimization target; and
step 2-4: calculating the adjustment ranges and the adjustment modes of the flights according to the normality target.

7. The flight schedule optimization method based on the flight normality target according to claim 6, wherein the step 2-1 comprises: defining the following variables:
TargetNormality: the set flight normality optimization target;
TmpNormality: a flight normality temporary variable;
TargetNum(Del): a number of flights that need to be deleted by filtering according to the normality target, wherein an initial value is 0;
TargetNum(Adj): a number of flights that need time adjustment by filtering according to the normality target, wherein an initial value is 0; and
TargetNum(Total): a number of flights that need time adjustment or deletion by filtering according to the normality target, wherein an initial value is 0.

8. The flight schedule optimization method based on the flight normality target according to claim 7, wherein the step 2-2 comprises:
recording the flight plan array FltArray as an array A, wherein the flight normality of the array A is estimated as FltNormality based on the step 1-3;
when the flights in the array FltArray are completely amended according to the sequencing result of the step 1-2, generating an array B, wherein the array B is capable of satisfying a national air traffic control service capacity, and no flight needs time adjustment or deletion according to the sequencing result of the step 1-2, so the flight normality estimated value of the array B is 100%; and
when a user sets the flight normality optimization target as TargetNormality, selecting an appropriate number of flights from the flight adjustment array FltArrayAdj, and amending the array FltArray according to the flight sequencing information to generate an array C, wherein the adjusted flight volume TargetNum(Total) filtered from FltArrayAdj needs to satisfy formula (3) and formula (4):
$$T arg etNormality = \frac{F l t A r r a y N u m ( N o r m a l ) + T arg etNum ( Adj )}{F l t A r r a y N u m - T arg etNum ( D e l )} , and \\ T arg etNum ( A d j ) ∈ [ 0 , F l t A r r a y N u m ( Delay ) ] , \\ T arg etNum ( D e l ) ∈ [ 0 , F l t A r r a y N u m ( D e l ) ] \qquad ( 3 )$$
$$T arg etNum ( T o t a l ) = T arg etNum ( A d j ) + T arg etNum ( Del ) \qquad ( 4 )$$
according to the sequencing result of the step 1-2, in order to ensure that the national air traffic control service capacity is not exceeded, (FltArrayNum(Delay)−TargetNum(Adj)) flights that need time adjustment and (FltArrayNum(Del)−TargetNum(Del)) flights that need deletion still exist in the array C; and a formula for verifying the flight normality of the array C is as follows:
$$\begin{matrix}TmpNormality = \frac{\begin{matrix}( FltArrayNum - T arg etNum ( Del ) ) - \\ ( FltArrayNum ( Delay ) - T arg etNum ( Adj ) ) - \\ ( FltArrayNum ( Del ) - T arg etNum ( Del ) )\end{matrix}}{FltArrayNum - T arg etNum ( Del )} \\ = \frac{\begin{matrix}FltArrayNum - FltArrayNum ( Delay ) - \\ FltArrayNum ( Del ) + T arg etNum ( Adj )\end{matrix}}{FltArrayNum - T arg etNum ( Del )} \\ = \frac{FltArrayNum ( Normal ) + T arg etNum ( Adj )}{FltArrayNum - T arg etNum ( Del )} \\ = T arg etNormality\end{matrix} . \qquad ( 5 )$$

9. The flight schedule optimization method based on the flight normality target according to claim 8, wherein the step 2-3 comprises:
limiting the flight normality optimization target set by the user, which needs to satisfy that TargetNormality∈[FltNormality,1]; and
the step 2-4 comprises:
step 2-4-1: calculating a deleted flight volume:
firstly, trying to achieve the normality optimization target by only deleting flight:
letting
$$T arg etNormality = \frac{F l t A r r a y N u m ( N o r m a l )}{F l t A r r a y N u m - T arg etNum ( D e l )} ,$$
then
$$T arg etNum ( D e l ) = FltA r rayNum - \frac{F l t A r r a y N u m ( N o r m a l )}{T arg etNormality} \qquad ( 6 )$$
when satisfying that TargetNum(Del)>FltArrayNum(Del), indicating that it is failed to achieve the flight normality target by deleting the flights only, letting TargetNum(Del)=FltArrayNum(Del), and continuously executing step 2-4-2; otherwise, letting TargetNum(Adj)=0, and skipping to step 2-4-3;
step 2-4-2: calculating a time-adjusted flight volume:
letting
$$T arg etNormality = \frac{F l t A r r a y N u m ( N o r m a l ) + T arg etNum ( Adj )}{F l t A r r a y N u m - T arg etNum ( D e l )} ,$$
then:
TargetNum(Adj)=TargetNormality*(FltArrayNum−TargetNum(Del))−FltArrayNum(Normal) (7); and
step 2-4-3: calculating a total adjusted flight volume:
TargetNum(Total)=TargetNum(Adj)+TargetNum(Del) (8).

10. The flight schedule optimization method based on the flight normality target according to claim 9, wherein the step 3 comprises the following steps of:
step 3-1: defining variables;
step 3-2: optimizing a sequence of the flight adjustment array; and
step 3-3: generating a flight schedule adjustment solution;
wherein in the step 3-1, the following variables are defined:
FltOptyList: flight adjustment solution, comprising the flights that need deletion or time adjustment filtered from the flight array FltArray in order to achieve the normality optimization target TargetNormality;
FltOptyᵢ: an i^{th} flight that needs to be optimized in FltOptyList;
FltOptyᵢ(CODE): a flight code of the flight FltOptyᵢ;
FltOptyᵢ(AdjMark): a flight adjustment mode type of FltOptyᵢ, wherein 0 represents time adjustment, and 1 represents suggested deletion;
FltOptyᵢ(STD): suggested time of departure of FltOptyᵢ;
FltOptyᵢ(STA): suggested time of arrival of FltOptyᵢ; and
MAX_DELAY: a default maximum flight delay;
the step 3-2 comprises:
step 3-2-1: updating delay information of flights suggested to be deleted:
for each flight Fltᵢ in the array FltArrayAdj, when the adjustment mode Fltᵢ(AdjMark) of the flight is 3, indicating that the flight is suggested to be deleted, letting the flight be that Fltᵢ(Delay)=MAX_DELAY;
step 3-2-2: sequencing according to delay situations of the flights:
sequencing the flights in a descending sequence of delays according to the delay situation Fltᵢ(Delay) of each flight Fltᵢ in the array FltArrayAdj, and updating a flight sequence in the array FltArrayAdj; and
step 3-2-3: sequencing according to the priorities of the flights:
on the basis of the step 3-2-2, sequencing the flights in a descending sequence of priorities according to the priority Fltᵢ(PRIO) of each flight Fltᵢ in the array FltArrayAdj, and updating the flight sequence in the array FltArrayAdj; and
the step 3-3 comprises:
step 3-3-1: filtering deleted flights:
filtering TargetNum(Del) flights Fltᵢ with an adjustment mode Fltᵢ(AdjMark) of 3 from a head of the array FltArrayAdj, defining the flights as flights FltOptyₖ to be optimized, and letting FltOptyᵢ(CODE)=Fltᵢ(ACID), and FltOptyₖ(AdjMark)=1; and adding FltOptyₖ into the flight adjustment solution FltOptyList; and
step 3-3-2: filtering time adjusted flights:
filtering TargetNum(Adj) flights Fltᵢ with an adjustment mode Fltᵢ(AdjMark) of 1 or 2 from the head of the array FltArrayAdj, defining the flights Fltᵢ as flights FltOptyₖ to be optimized, and letting FltOptyₖ(CODE)=Fltᵢ(ACID) FltOptyₖ(AdjMark)=0, FltOptyₖ(STD)=Fltᵢ(STD) and FltOptyₖ(STA)=Fltᵢ(STA); and adding FltOptyₖ into the flight adjustment solution FltOptyList.
